(19) United States
(12) Patent Application Publication
(10) Pub. No.: US 2018/0159385 A1
(43) Pub. Date: Jun. 7, 2018

(54) Silicon Steel Plate Used to Form a Stator of a Motor

(71) Applicant: Sunonwealth Electric Machine Industry Co., Ltd., Kaohsiung City (TW)

(72) Inventors: Alex Horng, Kaohsiung City (TW); Chi-Min Wang, Kaohsiung City (TW); Ku-Ling Liu, Kaohsiung City (TW)

(21) Appl. No.: 15/805,356

(22) Filed: Nov. 7, 2017

(30) Foreign Application Priority Data
Dec. 2, 2016 (TW) 105139984

(51) Int. Cl. H02K 1/14; H02K 1/02

(52) U.S. Cl. CPC H02K 1/146; H02K 1/02

(57) ABSTRACT

A silicon steel plate used to form a stator of a motor is disclosed. The silicon steel plate includes a plurality of magnetic pole units. Each of the plurality of magnetic pole units includes a magnetic yoke portion, a pole portion and a boost portion. The magnetic yoke portions of the plurality of magnetic pole units are connected as a magnetic yoke ring. The boost portion includes an inner face, and the inner faces of the boost portions of the plurality of magnetic pole units form a receiving hole. The receiving hole has a maximal diameter, the silicon steel plate has a maximal diameter, and a ratio of the maximal diameter of the receiving hole to the maximal diameter of the silicon steel plate is 0.54-0.84.

### CROSS REFERENCE TO RELATED APPLICATIONS

The application claims the benefit of Taiwan application serial No. 105139984, filed on Dec. 2, 2016, and the contents of which are incorporated herein by reference.

### BACKGROUND OF THE INVENTION

### 1. Field of the Invention

The present invention generally relates to a motor component and, more particularly, to a silicon steel plate used to form a stator of a motor.

### 2. Description of the Related Art

FIG. 1 shows a conventional silicon steel plate 9 of a stator of a motor. The silicon steel plate 9 includes a magnetic yoke ring 91. The magnetic yoke ring 91 can be mounted to a base of the motor (not shown). The silicon steel plate 9 further includes a plurality of magnetic poles 92 on an inner periphery thereof. The magnetic poles 92 are annularly spaced from each other in even intervals. At least one coil C may be wound around the magnetic poles 92. A boost portion 93 is arranged at an inner end of each magnetic pole 92 facing the central axis of the silicon steel plate 9, so as to provide a larger magnetically conducting area. The boost portions 93 of the magnetic poles 92 jointly form a receiving hole 94 for receiving a rotor (not shown). One example of such a conventional silicon steel plate 9 is shown in Taiwan Patent Nos. M490163 and M343331.

With the stator of the motor, the number of turns of the coil C is critical to the torque of the motor, but the number of turns of the coil C is limited to the length of the magnetic pole 92. Namely, the larger the length of the magnetic pole 92 the larger the space can be provided for the winding purposes (the coil C can have more turns). Therefore, the most efficient way to increase the torque of the motor is to increase the length of the magnetic poles 92.

Each magnetic pole 92 has an outer end connected to the inner periphery of the magnetic yoke ring 91. The outer end of each magnetic pole 92 can extend further outwards to increase the length of the magnetic pole 92. However, this will increase the maximal diameter W of the magnetic yoke ring 91, leading to an increase in the size of the silicon steel plate 9. In an occasion where a larger torque is required but the available motor space is limited (such as in a drone), the large-size silicon steel plate 9 cannot be used. If the inner end of each magnetic pole 92 is further extended inwards to increase the length of the magnetic pole 92, the diameter d of the receiving hole 94 will become smaller. As such, the size of the rotor needs to be reduced, which raises many design issues of the motor. Additionally, the space between the adjacent boost portions 93 becomes smaller, making it more inconvenient to proceed the winding process of the coil(s) C.

Another approach to increase the length of the magnetic pole 92 without changing the maximal diameter W of the magnetic yoke ring 91 and the diameter d of the receiving hole 94 is to reduce the width a between the inner and outer peripheries of the magnetic yoke ring 91. However, if the width a is too small, the silicon steel plate 9 cannot have a sufficient structural strength and can deform easily. This also affects the convenience in assembling the silicon steel plate 9 and the base of the motor as well as affects the coupling strength between the silicon steel plate 9 and the base of the motor. Therefore, there exists a need to improve the silicon steel plate 9.

### SUMMARY OF THE INVENTION

It is therefore the objective of this invention to provide a silicon steel plate used to form a stator of a motor. The silicon steel plate can provide a maximal winding space to increase the torque of the motor while maintaining a sufficient structural strength.

In an embodiment, a silicon steel plate used to form a stator of a motor is disclosed. The silicon steel plate includes a plurality of magnetic pole units. Each of the plurality of magnetic pole units includes a magnetic yoke portion, a pole portion and a boost portion. The magnetic yoke portions of the plurality of magnetic pole units are connected as a magnetic yoke ring. The boost portion includes an inner face, and the inner faces of the boost portions of the plurality of magnetic pole units form a receiving hole. The receiving hole has a maximal diameter, the silicon steel plate has a maximal diameter, and a ratio of the maximal diameter of the receiving hole to the maximal diameter of the silicon steel plate is 0.54-0.84.

In another embodiment, a silicon steel plate used to form a stator of a motor is disclosed. The silicon steel plate includes a plurality of magnetic pole units. Each of the plurality of magnetic pole units includes a magnetic yoke portion, a pole portion and a boost portion. The magnetic yoke portions of the plurality of magnetic pole units are connected as a magnetic yoke ring. The magnetic yoke ring has an inner periphery forming a receiving hole. The receiving hole has a maximal diameter, the silicon steel plate has a maximal diameter, and a ratio of the maximal diameter of the receiving hole to the maximal diameter of the silicon steel plate is 0.54-0.84.

Based on this, when each type of the silicon steel plate of the invention is used to form a motor, the silicon steel plate can have a larger winding space to increase the torque of the motor without changing the maximal diameter of the silicon steel plate. In this regard, the silicon steel plate can have a sufficient structural strength so that it can be securely coupled with the base of the motor. Furthermore, based on the ratio, the designer can quickly and correctly determine the type of the rotor that can be used with the silicon steel plate according to the maximal diameter of the silicon steel plate while ensuring a maximal winding space of the silicon steel plate. This eliminates the problems caused by improper size of the winding space of the silicon steel plate and reduces the time and effort in designing the product.

The ratio of the maximal diameter of the receiving hole to the maximal diameter of the silicon steel plate is 0.6-0.7.

The maximal diameter of the silicon steel plate is 50-150 mm.

A quantity of the pole portions of the plurality of magnetic pole units is a multiple of 3. The quantity of the pole portions is 12 or more.

The magnetic yoke ring has an inner periphery and an outer periphery, the pole portion has a width, and the maximal width of the magnetic yoke ring between the inner and outer peripheries is larger than or equal to a half of the width of the pole portion. In this arrangement, the structural strength of the silicon steel plate can be enhanced.

The pole portion has a width, the boost portion has a width in a radial direction of the receiving hole, and the width of the boost portion is 0.1-0.7 times the width of the pole portion. In this arrangement, the winding space of the silicon steel plate can be increased.

The magnetic yoke portion has an outer edge forming a positioning groove. This structure can enhance the coupling strength between the silicon steel plate and the base of the motor.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a conventional silicon steel plate used to form a stator of a motor.

FIG. 2 shows a plan view of a silicon steel plate according to a first embodiment of the invention.

FIG. 3 is an exploded view of an inner-rotor motor having a rotor and a stator formed by a plurality of the silicon steel plates of the first embodiment of the invention.

FIG. 4 is a cross sectional view of the inner-rotor motor shown in FIG. 3.

FIG. 5 is a cross sectional view of the inner-rotor motor taken along the line A-A of FIG. 4.

FIG. 6 is an exploded view of another inner-rotor motor having another type of the rotor.

FIG. 7 shows a plan view of a silicon steel plate according to a second embodiment of the invention.

In the various figures of the drawings, the same numerals designate the same or similar parts. Furthermore, when the terms “inner”, “outer”, “radial”, “length”, “width” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

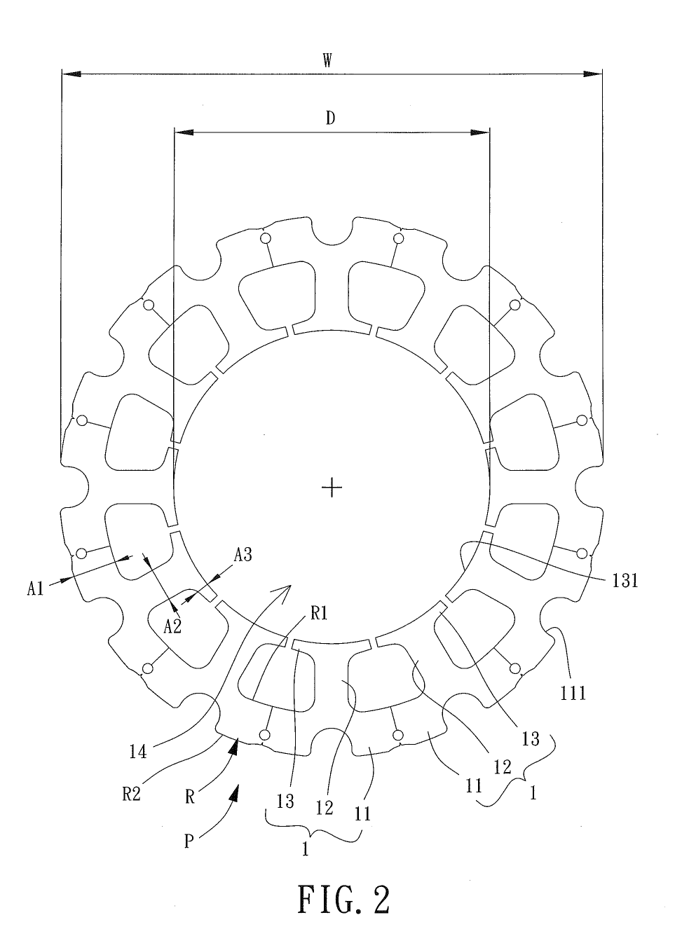

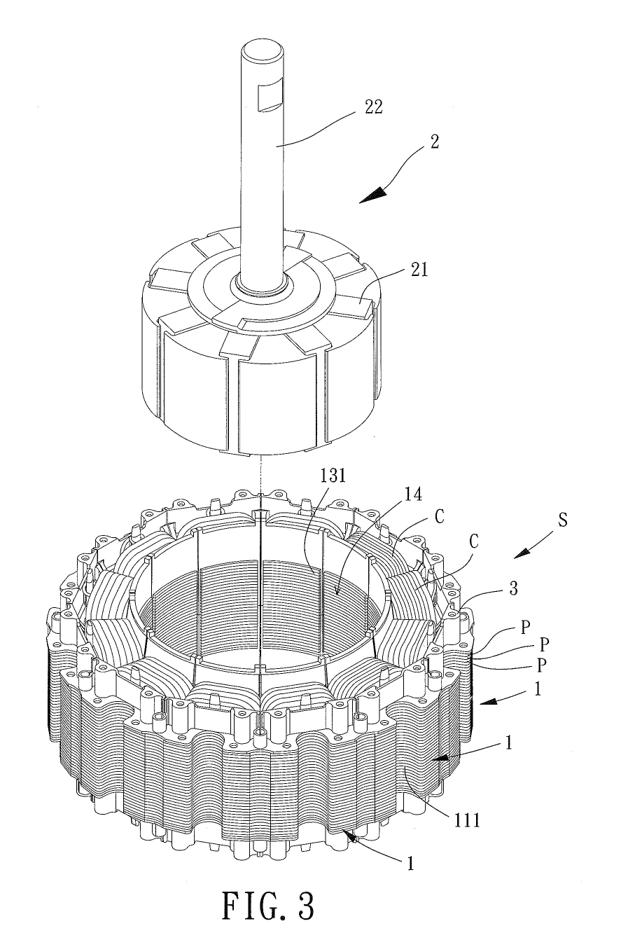

FIGS. 2 and 3 show a silicon steel plate P used to form a stator of a motor according to a first embodiment of the invention. The silicon steel plate P includes a plurality of interconnected magnetic pole units 1. Each magnetic pole unit 1 includes a magnetic yoke portion 11, a pole portion 12 and a boost portion 13. The magnetic yoke portion 11, the pole portion 12 and the boost portion 13 can be integrally formed together or can be connected to each other by any structures or methods. The invention is not limited to either option.

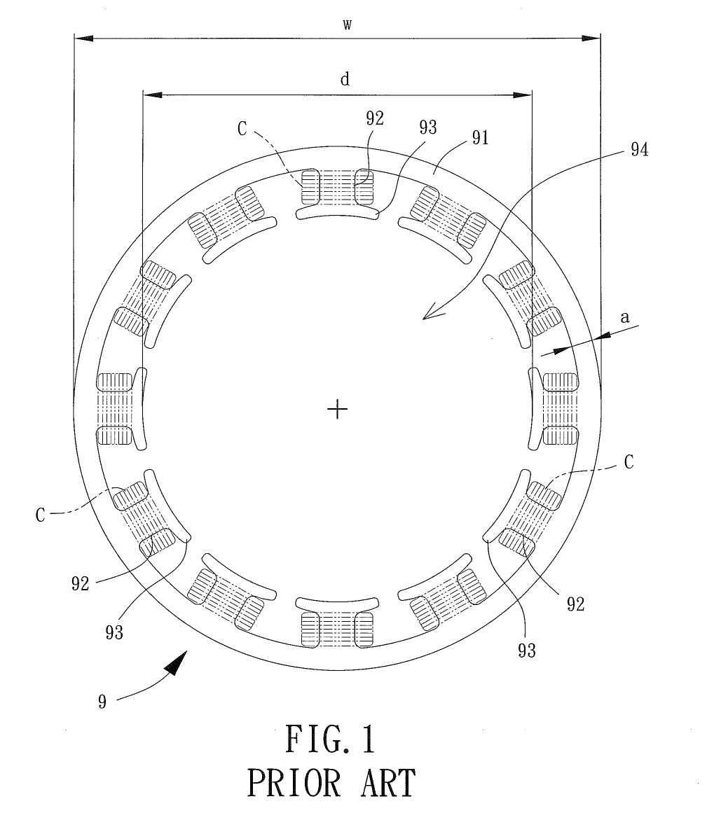

Specifically, the magnetic yoke portions 11 of the magnetic pole units 1 are connected to form a magnetic yoke ring R. The quantity of the pole portions 12 of the silicon steel plate P may be a multiple of 3, and is preferably 12 at least. The boost portion 13 includes an inner face 131 that increases the magnetically conductive area of the pole portion 12. The inner faces 131 of the boost portions 13 are annularly arranged to form a receiving hole 14, and a magnet portion 21 of a rotor can be rotatably received in the receiving hole 14. In a non-limiting example, the magnetic yoke portions 11 of the magnetic pole units 1 are arranged in a line. Then, a plurality of silicon steel plates P is stacked with each other in a manner where the pole portions 12 of the stacked magnetic pole units 1 are aligned with each other. Next, an insulating bobbin unit 3 is attached to the stacked silicon steel plates P and a coil C is wound around each column of the pole portions 12. Finally, the silicon steel plates P are bent into an annular shape to form a stator S of an inner-rotor motor. As such, the winding process of the coil C is convenient. In another embodiment, the magnetic yoke portions 11 of the silicon steel plates P can also be integrally formed together (as it is the case of FIG. 1) rather than being bent into the annular shape.

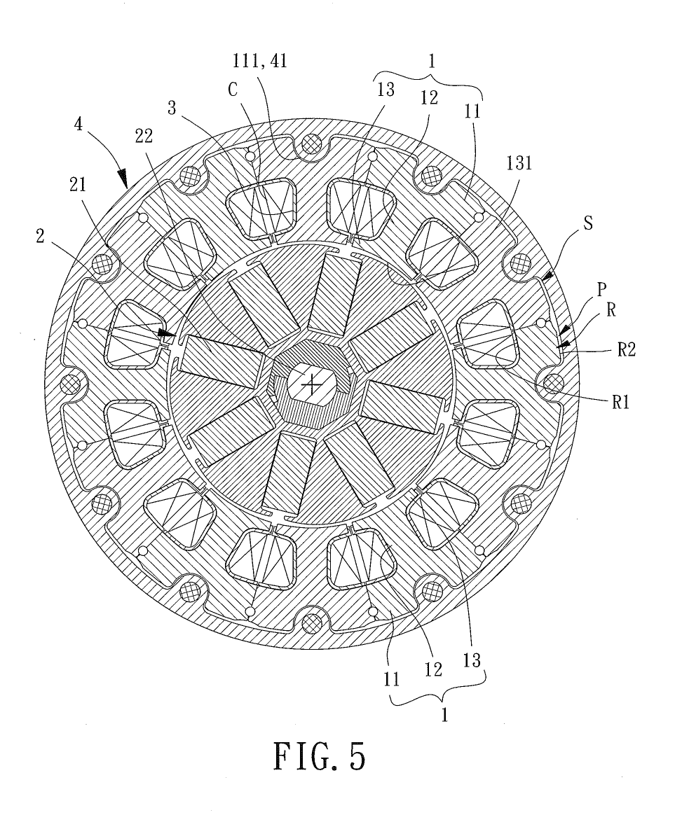

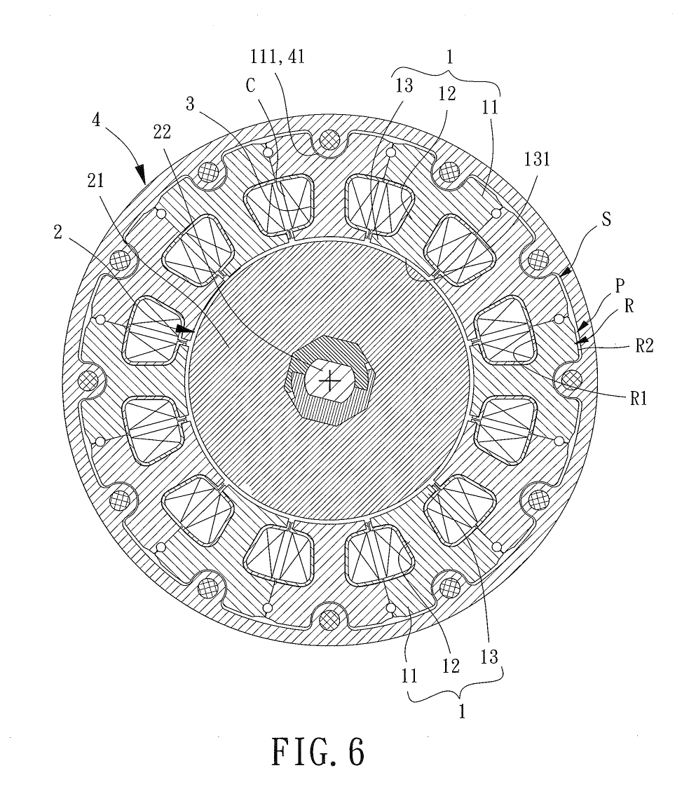

Referring to FIGS. 2, 4 and 5, a positioning groove 111 is formed on the outer edge of the magnetic yoke portion 11. Thus, the motor includes a base 4 having a plurality of positioning protrusions 41 formed on the inner periphery of the base 4. The positioning protrusions 41 can be respectively inserted into the positioning grooves 111 to prevent the stator S from rotating relative to the base 4 after assembly, enhancing the coupling effect between the stator S and the base 4. It is noted that the shape of the rotor 2 is not limited in the invention, namely, the stator S formed by the silicon steel plates P can also be used with the rotor 2 of FIG. 6.

Referring to FIG. 2, the receiving hole 14 of the silicon steel plate P has a maximal diameter D, and the silicon steel plates P have a maximal diameter W. The ratio of D/W is preferably between 0.54-0.84, and is more preferably between 0.6-0.7. The maximal diameter W of the silicon steel plate P is preferably between 50-150 mm.

Based on this, when the motor is to be installed in a system, the maximal diameter W of the silicon steel plate P can be determined as long as the available motor space of the system is given. Then, the maximal diameter D can be calculated based on the ratio of D/W. As such, the type of the rotor that can be used with the stator S (as the one shown in FIG. 3) can be determined without having to increase the size of the silicon steel plate P. This can also enlarge the winding space of the silicon steel plates P. Advantageously, the silicon steel plate P of the invention can provide the largest torque among those having the same maximal diameter D.

In particular, in this embodiment, the maximal width A1 of the magnetic yoke ring R between the inner periphery R1 and the outer periphery R2 can be set as a value larger than or equal to a half of the width A2 of the pole portion 12. This ensures that the magnetic yoke ring R of the silicon steel plate P has a sufficient structural strength to support the pole portions 12 and the coils C without deformation, improving the quality of the silicon steel plate P.

Besides, the boost portion 13 has a width A3 in a radial direction of the receiving hole 14. When the interconnected part between the pole portions 12 and the boost portion 13 is in a right angle, the width A3 is the distance between the interconnected part and the inner face 131 of the boost portion 13 in the radial direction. When the interconnected part between the pole portions 12 and the boost portion 13 is in the form of an arc, the width A3 is the distance between the inner face 131 of the boost portion 13 and an end of the arc adjacent to the free end of the boost portion 13. The width A3 is approximately 0.1-0.7 times the width A2 of the pole portions 12, thus enlarging the winding space of the silicon steel plates P.

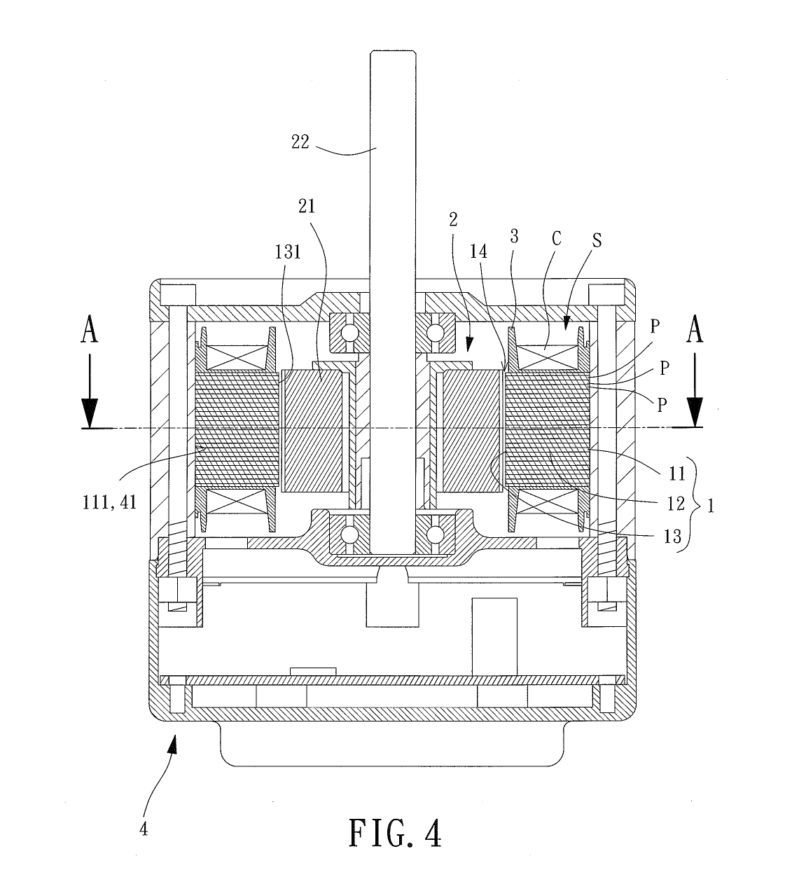

Referring to FIG. 4, based on the above structure, the stator S can be mounted to the inner circumferential face of the base 4, and the magnet portion 21 of the rotor 2 is aligned with and disposed into the receiving hole 14 of the stator S. In this regard, the outer faces of the magnet portions 21 respectively face the inner faces 131 of the boost portions 13, and a shaft 22 is provided to connect the magnet portions 21. In this arrangement, when one or more coils C of the stator S are electrified, a magnetic repulsive force is generated between the corresponding boost portions 13 and the magnet portions 21 of the rotor 2, driving the shaft 22 to rotate.

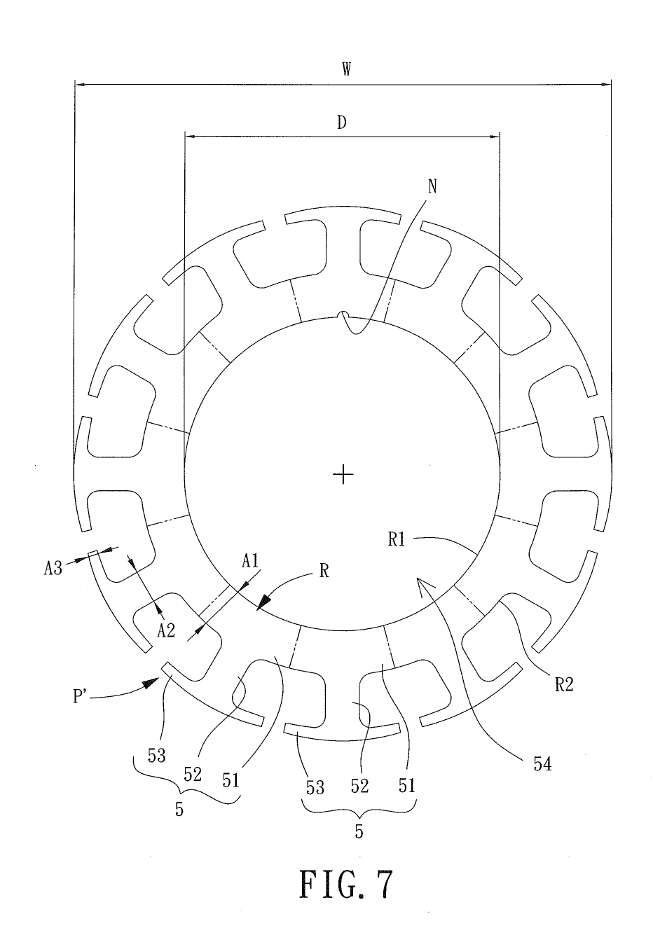

FIG. 7 shows a silicon steel plate P′ used to form a stator of a motor according to a second embodiment of the invention. The silicon steel plate P′ includes a plurality of interconnected magnetic pole units 5. Each magnetic pole unit 5 includes a magnetic yoke portion 51, a pole portion 52 and a boost portion 53. The pole portion 52 connects the magnetic yoke portion 51 with the boost portion 53. The magnetic yoke portions 51 of the magnetic pole units 5 are connected to form a magnetic yoke ring R. In this embodiment, the magnetic yoke portions 51 of the magnetic pole units 5 can be integrally formed together rather than being bent into the annular shape. In FIG. 7, the broken lines are used to distinguish each magnetic yoke portion 51 from other magnetic yoke portions 51 for illustration purpose. In another embodiment, the magnetic yoke portions 51 of the magnetic pole units 5 can also be arranged in a line and then are bent into the annular shape.

The inner periphery R1 of the magnetic yoke ring R forms a receiving hole 54 having a maximal diameter D, and the silicon steel plates 5 have a maximal diameter W. The ratio of D/W is preferably between 0.54-0.84, and is more preferably between 0.6-0.7. The maximal diameter W of the silicon steel plate 5 is preferably between 50-150 mm. Based on this, the silicon steel plate 5 is able to achieve various advantages of the silicon steel plate P of the first embodiment. It is noted that if the magnetic yoke ring R includes a notch N on the inner periphery thereof, the measurement of the maximal diameter D does not involve the notch N.

In summary, each type of the silicon steel plate as discussed in the respective embodiment of the invention is able to increase the torque of the motor by enlarging the winding space without changing the maximal diameter of the silicon steel plate. In this regard, the silicon steel plate can have a sufficient structural strength so that it can be securely coupled with the base of the motor. Furthermore, based on the ratio, the designer can quickly and correctly determine the type of the rotor that can be used with the silicon steel plate according to the maximal diameter of the silicon steel plate while ensuring a maximal winding space of the silicon steel plate. This eliminates the problems caused by improper size of the winding space of the silicon steel plate and reduces the time and effort in designing the product.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A silicon steel plate used to form a stator of a motor, comprising a plurality of magnetic pole units, wherein each of the plurality of magnetic pole units comprises a magnetic yoke portion, a pole portion and a boost portion, wherein the magnetic yoke portions of the plurality of magnetic pole units are connected as a magnetic yoke ring, wherein the boost portion comprises an inner face, and the inner faces of the boost portions of the plurality of magnetic pole units form a receiving hole, wherein the receiving hole has a maximal diameter, the silicon steel plate has a maximal diameter, and a ratio of the maximal diameter of the receiving hole to the maximal diameter of the silicon steel plate is 0.54-0.84.

2. The silicon steel plate used to form the stator of the motor as claimed in claim 1, wherein the magnetic yoke portion has an outer edge forming a positioning groove.

3. The silicon steel plate used to form the stator of the motor as claimed in claim 1, wherein the ratio of the maximal diameter of the receiving hole to the maximal diameter of the silicon steel plate is 0.6-0.7.

4. The silicon steel plate used to form the stator of the motor as claimed in claim 1, wherein the maximal diameter of the silicon steel plate is 50-150 mm.

5. The silicon steel plate used to form the stator of the motor as claimed in claim 1, wherein a quantity of the pole portions of the plurality of magnetic pole units is a multiple of 3.

6. The silicon steel plate used to form the stator of the motor as claimed in claim 5, wherein the quantity of the pole portions is 12 or more.

7. The silicon steel plate used to form the stator of the motor as claimed in claim 1, wherein the magnetic yoke ring has an inner periphery and an outer periphery, wherein the pole portion has a width, and wherein a maximal width of the magnetic yoke ring between the inner and outer peripheries is larger than or equal to a half of the width of the pole portion.

8. The silicon steel plate used to form the stator of the motor as claimed in claim 1, wherein the pole portion has a width, wherein the boost portion has a width in a radial direction of the receiving hole, and wherein the width of the boost portion is 0.1-0.7 times the width of the pole portion.

9. A silicon steel plate used to form a stator of a motor, comprising a plurality of magnetic pole units, wherein each of the plurality of magnetic pole units comprises a magnetic yoke portion, a pole portion and a boost portion, wherein the magnetic yoke portions of the plurality of magnetic pole units are connected as a magnetic yoke ring, wherein the magnetic yoke ring has an inner periphery forming a receiving hole, wherein the receiving hole has a maximal diameter, the silicon steel plate has a maximal diameter, and a ratio of the maximal diameter of the receiving hole to the maximal diameter of the silicon steel plate is 0.54-0.84.

10. The silicon steel plate used to form the stator of the motor as claimed in claim 9, wherein the ratio of the maximal diameter of the receiving hole to the maximal diameter of the silicon steel plate is 0.6-0.7.

11. The silicon steel plate used to form the stator of the motor as claimed in claim 9, wherein the maximal diameter of the silicon steel plate is 50-150 mm.

12. The silicon steel plate used to form the stator of the motor as claimed in claim 9, wherein a quantity of the pole portions of the plurality of magnetic pole units is a multiple of 3.

13. The silicon steel plate used to form the stator of the motor as claimed in claim 12, wherein the quantity of the pole portions is 12 or more.

14. The silicon steel plate used to form the stator of the motor as claimed in claim 9, wherein the magnetic yoke ring has an inner periphery and an outer periphery, wherein the pole portion has a width, and wherein a maximal width of the magnetic yoke ring between the inner and outer peripheries is larger than or equal to a half of the width of the pole portion.

15. The silicon steel plate used to form the stator of the motor as claimed in claim 9, wherein the pole portion has a width, wherein the boost portion has a width in a radial direction of the receiving hole, and wherein the width of the boost portion is 0.1-0.7 times the width of the pole portion.
